(19) United States
(12) Patent Application Publication
(10) Pub. No.: US 2003/0229536 A1
(43) Pub. Date: Dec. 11, 2003

(54) Media planning and buying system and method

(76) Inventors: Sandra Miller House, Chicago, IL (US); Nathan George Laurell, Chicago, IL (US); John Edward Olson, Chicago, IL (US); Christopher Karl Thompson, Chicago, IL (US); Dean Alan Rutter, Evanston, IL (US)

Correspondence Address: BARNES & THORNBURG, P.O. BOX 2786, CHICAGO, IL, 60690-2786, US

(21) Appl. No.: 10/389,376

(22) Filed: Mar. 14, 2003

Related U.S. Application Data
(60) Provisional application No. 60/364,265, filed on Mar. 14, 2002.

(51) Int. Cl. G06F 17/60

(52) U.S. Cl. 705/10

(57) ABSTRACT

This disclosure relates to a system, method, computer program product, and data signal for providing local marketers with an affordable, efficient, media-related service for planning and executing a marketing communications campaign using a computer-implemented system. The system and method provides the advantages typically available only to larger purchasers without having to maintain the advertising budgets of such large purchasers. The system allows the user to input preferences about the media/communications campaign into interactive worksheets. The preferences are used by a set of intelligent decision rules to produce prototype plans which present a week-by-week schedule of media purchasing as well as an allocation to various media/communications classifications. The system also allows the purchaser to vary the preferences and see the effects of the variations on the prototype plans. Once a plan is approved, the system facilitates media purchases with strategic media/communications providers at discounted rates. This system provides the small purchasers with all the buying clout of a large purchaser, provides expertise to those who may lack it, and significantly reduces the time and costs currently required for media planning and buying.

### RELATED APPLICATIONS

This application claims priority under 35 USC §119(e) to of U.S. Provisional Application No 60/364,265, filed Mar. 14, 2002, which is expressly incorporated by reference herein.

### BACKGROUND

The discipline of marketing communications uses a range of communications classifications to deliver selling messages to potential customers. Mass media advertising, typically defined as paid time or space on classifications such as broadcast stations, cable TV, Internet and other electronic media; and print publications or public signs is the most widely known and visible. Marketing communication classifications also include such classifications as direct mail advertising, sponsorship of sporting events or other special events, and product sampling programs.

Companies purchased $215 billion of mass-media advertising in the U.S. in 1999. Over $70 billion was spent in 2001 just for direct mail advertising. These types of media were purchased by two primary categories of advertisers. The first group consists of large purchasers who spent more than $2 million and represented 46% of all purchased media in 1999 (“Large Purchasers”). Many of the Large Purchasers are Fortune 1000 companies who are primarily served by large and small full service agencies and by international independent media buying companies.

The small to mid-size purchasers (“Small-mid Purchasers”) who spent less than $2 million make up 54% of the dollars spent on advertising in 1999. Individually, Small-mid Purchasers spend less on average than Large Purchasers although the number of Small-mid Purchasers are greater than the number of Large Purchasers. Small-mid Purchasers' budgets are not large enough to attract the quality and breadth of service offered to Large Purchasers. As a result, Small-mid Purchasers currently are served by boutique agencies, freelance media buyers or directly by the media outlets.

To further describe the problems faced by Small-mid Purchasers, it is useful to categorize them into 4 groups. Although the four groups serve different roles, they all share problems associated with not being a Large Purchaser. The first group consists of local companies, and more particularly, the local company's marketing manager. The second group consists of local market managers of large entities (i.e. multi-unit company or affiliated member of a national or regional organization). In many situations the responsibility for local market spending is not handled directly by headquarters, but rather delegated to local market managers. Although the large entity's budget is large, each individual local market manager's budget is not. Consequently, these local managers in effect have the limited buying power and limited clout of the local companies. Both of these groups, unable to draw larger advertising firms, are forced to purchase their media on their own, through smaller agencies, or through freelance media buyers.

The third group of Small-mid Purchasers are the small professional service firms, boutique agencies, and freelance media buyers themselves. Although providing services to the local purchasers, these small professional firms themselves still may lack the size, buying power, and clout enjoyed by Large Purchasers. As a result, these small firms face the similar small company problems.

The fourth group is professional media planners which are responsible for a variety of time consuming functions including gathering rate information, manually collecting and entering data into flowcharts, calculating costs, and calculating advertising reach. This group has a need for automation to reduce human error and reduce cost.

The problems faced by Small-mid Purchasers can be divided into the following three categories. First, Small-mid Purchasers lack the expertise needed to make efficient and effective decisions on advertising purchasing and allocations. Second, Small-mid Purchasers do not have budgets sufficient to either purchase or to attract services from large advertising agencies. Finally, Small-mid Purchasers may lack the resources to effectively monitor their purchasers and to gauge how well their advertising worked.

With regard to expertise, Small-mid Purchasers need trustworthy advice in media planning on what is worth buying and what is not and on how to make the best use of the dollars they have. This requires expertise in the local media marketplace. Often the media professionals available for Small-mid Purchasers have less experience and fewer resources available. As a result, Small-mid Purchasers have a need for a lower-cost, high quality expert media buying advice.

The second problem area for Small-Mid Purchasers is purchasing clout. Small-mid Purchasers often pay more than they should because the best placement and pricing is often given to Large Purchasers. In addition, because Small-Mid Purchasers are labor intensive relative to their budgets, they often pay a higher proportion of their media budgets in fees and commissions rather than having the dollars go directly to purchasing media.

A related problem faced by Small-mid Purchasers is the distraction from core business activities. For most Small-mid Purchasers, media buying activities take time away from their core business activities. They need tools that make this process efficient and effective and allow them to focus on their “real jobs.” As a result, there is a need for a computer based system, which automates media buying decisions which would result in time savings to Small-mid Purchasers. Such a system would allow Small-mid Purchasers to focus their best efforts on their own jobs, while still receiving the highest quality media purchasing expertise.

The third major problem area for Small-mid Purchasers is the difficulty in assessing the effectiveness of advertising. Small-mid Purchasers have a need to know whether the media that they purchased ran as scheduled, whether it delivered the intended audience and how it correlates with their advertising objectives. Because of the considerable time and expense of such monitoring, there is still a more particular need for a computerized monitoring, analysis, and feedback system.

### SUMMARY

This disclosure relates to a system, method, and computer program product for providing local market advertisers and their advertising agencies with computer-assisted, affordable, efficient media-related service. The system and method provides at least two significant advantages over prior art methods: media planning in far less time and with far less labor, and purchases at rates typically available only to Large Purchasers without having to maintain the advertising budgets of Large Purchasers. The processes and technology applied to this system will also be used to develop optimized solutions for other types of marketing communications classifications. This will include developing optimized solutions and budgets for a range of marketing tactics, such as sampling, event sponsorship, displays, couponing and sports sponsorships and mass-media advertising. The system may also be applied to generate, through automation, direct mail plans and budgets optimized to meet users' needs.

The system allows local market advertisers and their advertising agencies to input a set of plan parameters into interactive worksheets. The parameters are applied to a set of decision rules which guide an intelligent planning engine to produce prototype plans which present a week-by-week schedule of media purchasing as well as an allocation to various media classifications. The system allows the user to vary the preferences and see the effects of the variations in the prototype plans. After a plan is approved, the system facilitates media purchases with strategic media providers at discounted rates. The user is able to monitor the progress of the negotiations, view and approve proposed purchases, view final reports on the performance of the purchases, and share documents via email and documents uploaded to client's online file.

### BRIEF DESCRIPTION OF THE DRAWINGS

The disclosed system and method and the advantages thereof will become more apparent upon consideration of the following detailed description when taken in conjunction with the accompanying drawings:

FIG. 1 is a general diagrammatic illustration of the stages of the media planning and analysis, buying, and monitoring system;

FIG. 2 is a flowchart of data entered by the user into the interactive worksheets;

FIG. 3 is a flowchart stepping through running the data through the decision rules;

FIG. 4 is a flowchart of the analysis portion of the planning and analysis stage;

FIG. 5 is a flowchart of buying stage;

FIG. 6 is a flowchart of the monitoring and post-buy analysis stage;

FIGS. 7-15 are interactive worksheets used to gather the user's media campaign preferences;

FIG. 16 is a summary screen which provides an editable global view of collected information;

FIG. 17 is a screen in which a user may select one of 5 prototype plans for viewing and comparison;

FIG. 18A is a sample chart depicting a media plan for a balanced motivate action advertising campaign;

FIG. 18B is a continuation of FIG. 18A;

FIG. 19 is a flowchart of steps involved in selecting geographically targeted media;

FIG. 20 is a screen of the system which allows the user to change plan variables to recalculate the prototype plans to produce revised plans;

FIG. 21 is an example of a decision rule matrix chart; and

FIG. 22 is a simple diagrammatic view showing components of a system for media planning and buying.

### DETAILED DESCRIPTION OF THE DRAWINGS

While the present disclosure may be susceptible to embodiment in different forms, there is shown in the drawings, and herein will be described in detail, embodiments with the understanding that the present disclosure is to be considered an exemplification of the principles of the system and method and is not intended to be limited to the details of construction and the arrangements of components set forth in the following description or illustrated in the drawings.

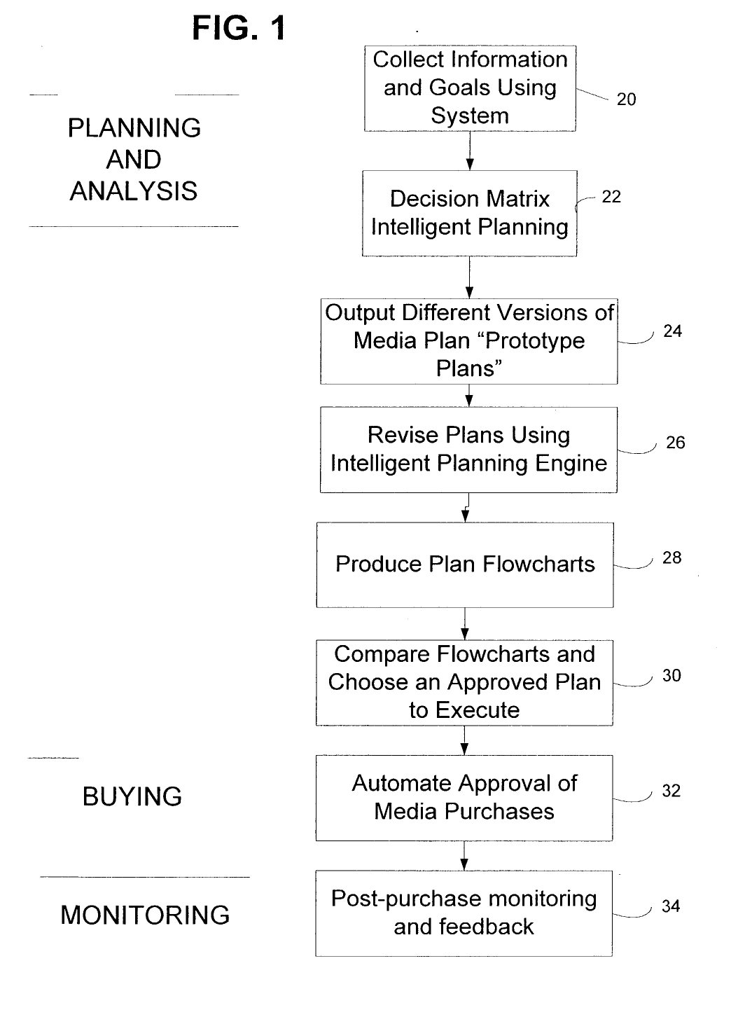

The system 20 provides computer-aided interface to facilitate media planning over three stages. Referring to FIG. 1 which is a global view of the method, a first “Planning and Analysis Stage” involves information and goals being collected from the user. Next, this data is run through an intelligent decision matrix planning tool 22 a number of different versions of a media flow chart, referred to as prototype plans 24. At this point, plans may be revised using the intelligent planning engine 26. Viable plan flowcharts 28 are then compared and presented to the user who approves one of the plans, referred to an approved plan 30. In a second “Buying Stage,” the media plan is executed by automating an approval of a media purchase 32 from strategic media partners 32. Finally, in a third “Monitoring Stage,” the user is able to use the system 20 to monitor the execution of the media purchases and access market research through strategic partnerships 34. A more detailed description of each of these stages follows below.

Stage 1. Media Planning and Analysis

In the first stage, a planning function is performed through a combination of using the system 20 and human counseling and advice. The system 20 uses a set of decision rules to meet marketing communication objectives selected by the user from a menu. Media cost data including data for radio, TV, outdoor, Internet advertising, direct mailing and other media types is gathered from a database accessible by the system. The type of database and data accessed is determined by parameters selected by the user such as a media type and budget. It is contemplated that this system 20 is used in conjunction with a human expert so at any point in which the automated planning process is not sufficient to meet client needs, the user can bring in the human expert for additional assistance.

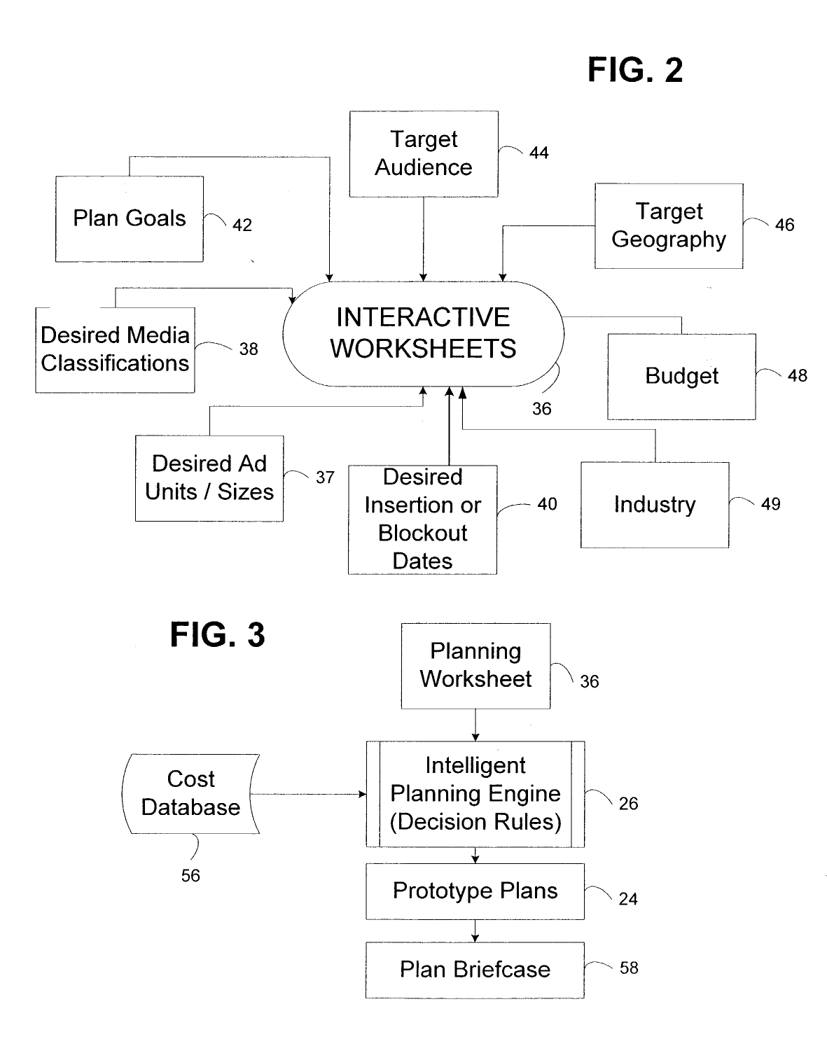

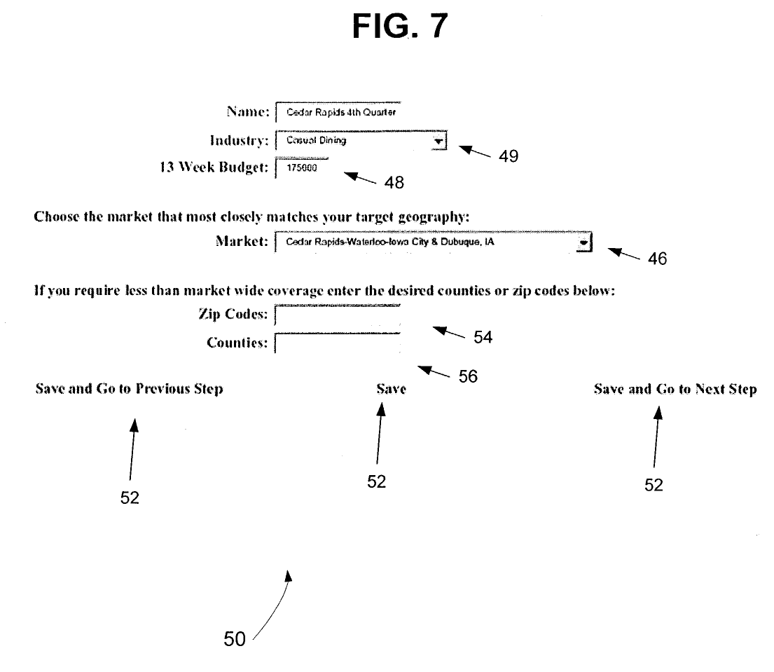

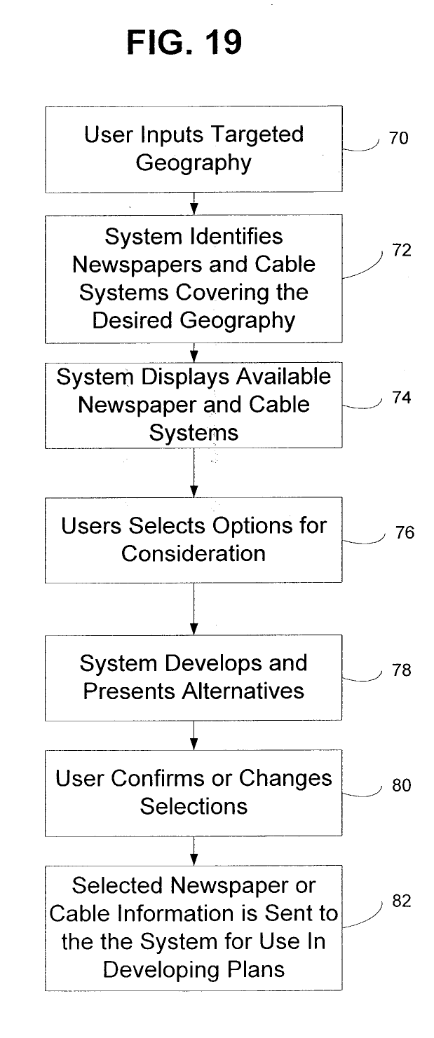

As seen in FIG. 2, the user inputs data into interactive guided worksheets 36 to collect basic client and campaign information, detailed plan requirements, target audience characteristics, and media type preferences. The information requested by system 20 includes but is not limited to desired ad units or sizes 37, desired media classifications 38, desired insertion or block-out dates 40, plan goals 42, target audience 44, target geography 46, budget 48, and industry 49. FIG. 7 is an example of one embodiment of a first interactive worksheet 50 which prompts the user for information, such as industry 49 and budget 48, as well as general advertising objectives using a commonly known drop down menu interface that may also include buttons 52 to save or navigate through the system 20. Other options, such as limiting the geographic region 46 to a particular zip code 54 or county 56, may also be presented (FIG. 19). Throughout the intake process, tutorials are available to the user to help improve their understanding of the media industry terms and concepts that are used in the process.

As an example, when the selected media type is direct mailing, the user may be prompted to additionally select other campaign parameters such as desired mailing piece specifications, desired postage classifications, the user's need for alternative test patterns, desired mailing dates, desired number of mailings, plan goals, expected response rates and a monetary value to the user of each response, target audience, target geography, budget and industry.

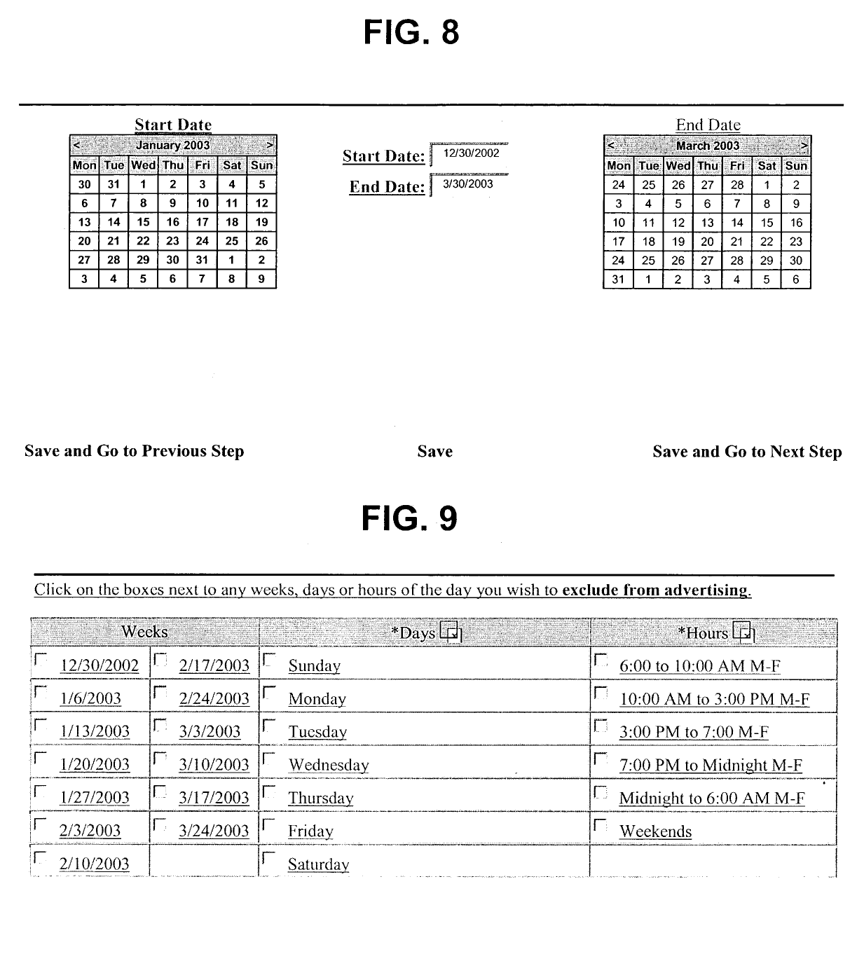

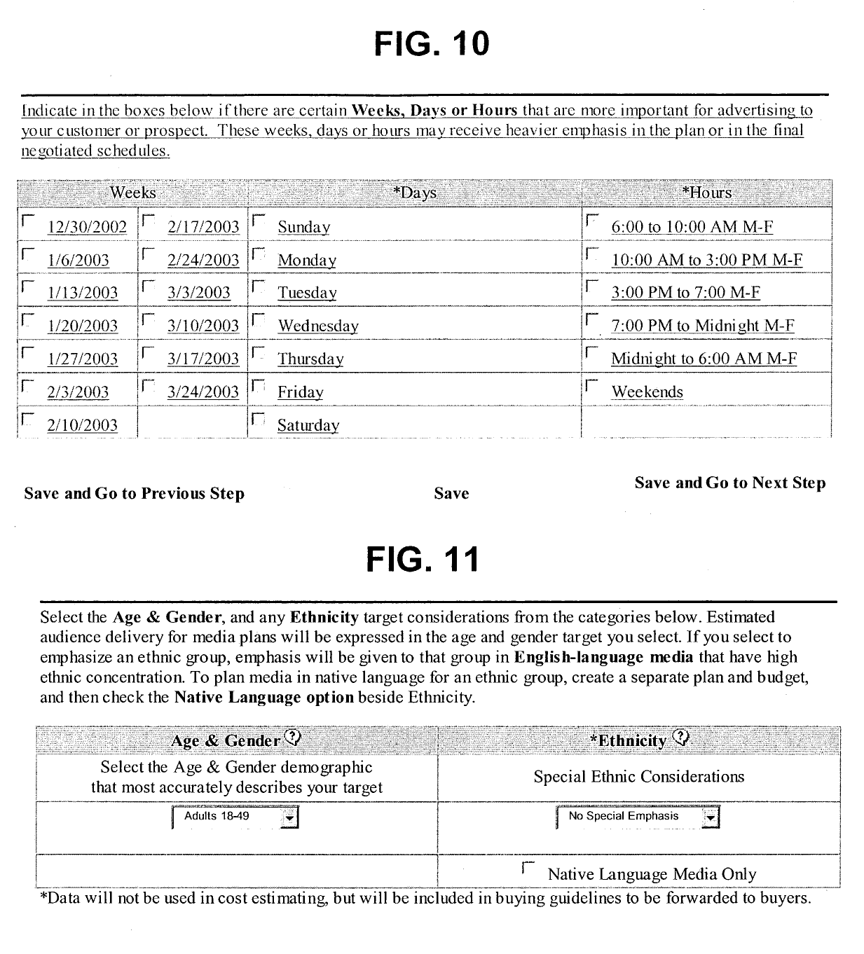

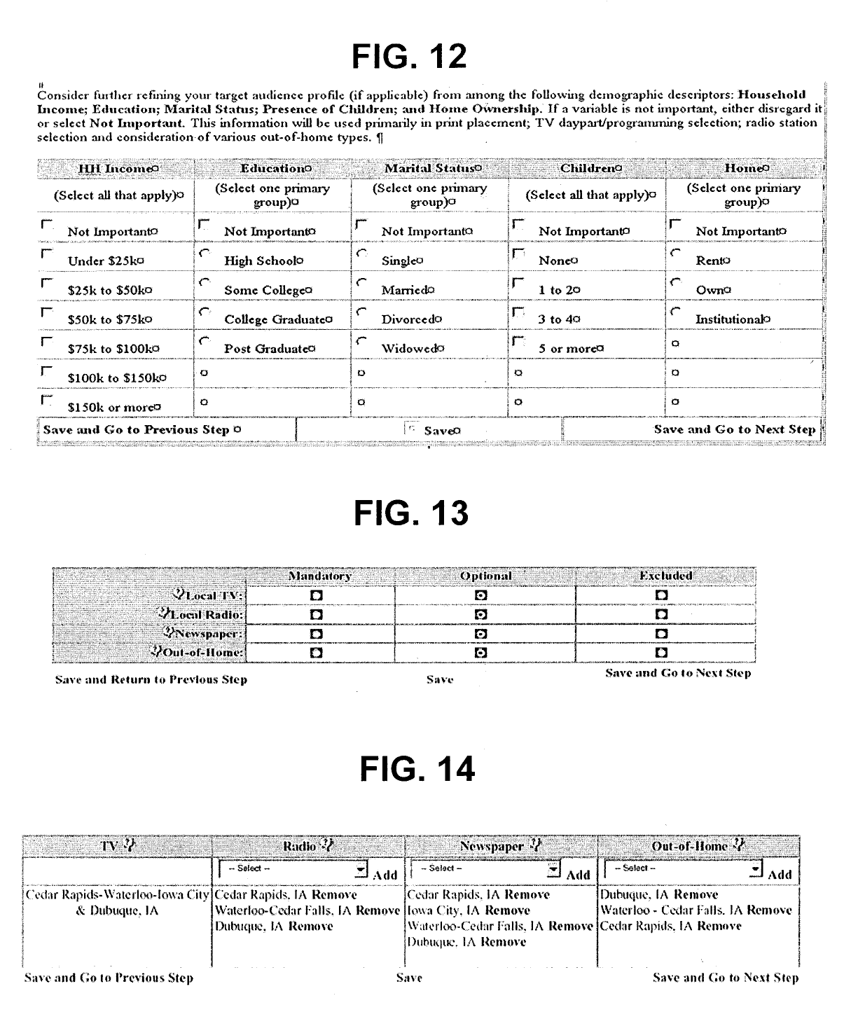

FIG. 8 is a screen presenting the user with further questions, this time including the estimated planning period, which may be input using field boxes or a calendar interface. FIG. 9 and FIG. 10 are screens asking for time restrictions and preferences, which may include times, dates, and other durations when advertising should or should not be scheduled. FIG. 11 and FIG. 12 are screens asking for target demographics such as age, gender, ethnicity, and other important demographics including household income, education, marital status, number of children, home ownership status, native language preferences, and settings related to ethnicity. An example of an instructional prompt is shown at the top of FIG. 11 and FIG. 12.

FIG. 13 and FIG. 14 are screens instructing the user to allocate a priority of various media classifications including local television, local radio, local newspaper and out-of-home. Using the screen shown in FIG. 14, the user can further specify the geographic area to be covered by deselecting any of the media markets listed. Deselected markets are not considered for inclusion in alternative plans.

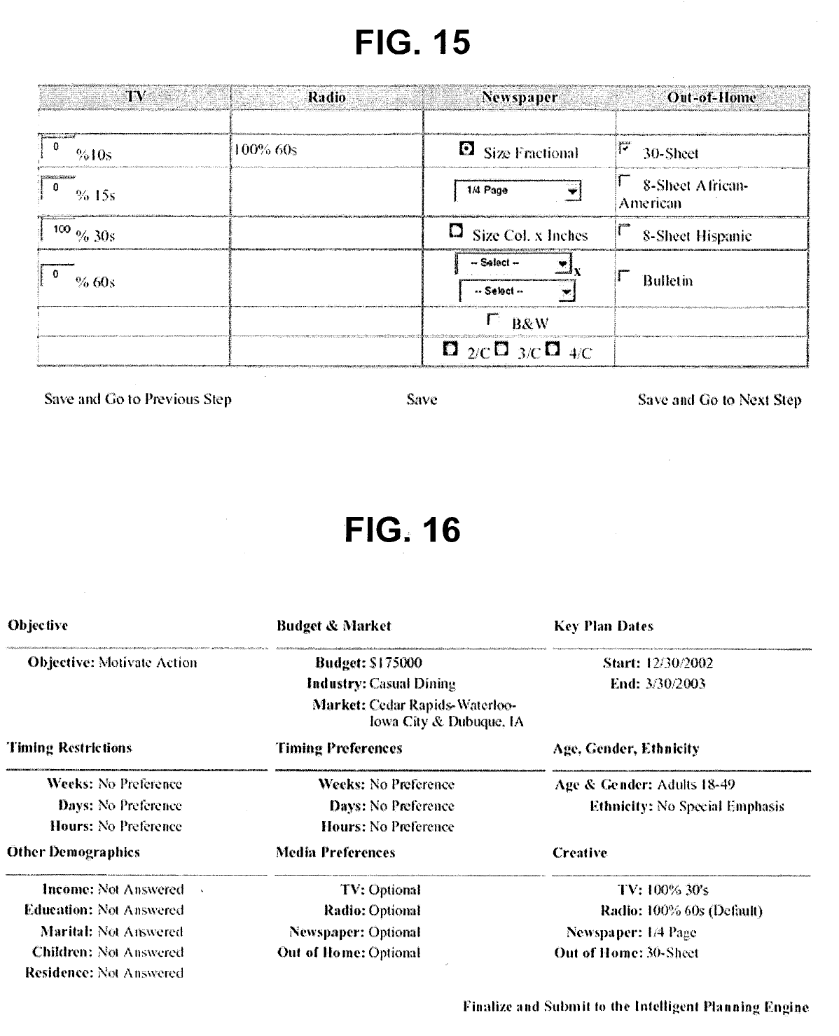

FIG. 15 shows a screen in which a user may input or select media specific preferences such as ad sizes. FIG. 16 shows a summary screen which provides an editable global view of the collected information.

Referring now to FIG. 3, a second step of the media planning stage is to run the information entered in the previous stage into the planning worksheets 36 through a set of decision rules accessible by an intelligent planning engine 26. The intelligent planning engine 26 may be implemented as a function, a routine call, or may be a separate program stored on the system 20. For convenience, calculations and outputs for producing plans will be collectively referred to as the intelligent planning engine 26.

The intelligent planning engine 26 analyzes the user information by pulling information from cost databases 56 containing information related to the costs of various media in the local market(s) in which the client will advertise. One example of such a database is the television and radio cost database provided by SQAD, Inc. SQAD is a service providing this data to advertising agencies and advertisers in the U.S. and is highly respected in the industry. A second example is the out-of-home media cost database provided by Outdoor Services, Inc. A third example is the proprietary newspaper cost database developed by MediaMixNet, Inc. Cost data may also be stored on the system 20 for retrieval.

As an example, where the selected media type is direct mailing, the cost data may include cost data for rental, printing, handling, postage, and fulfillment. The database 56 may also contain (a) ready list of sources of mailing lists including name and addresses of persons or companies who may be good prospects for the products or services they wish to sell; (b) costs of acquiring those lists for direct mail advertising purposes; (c) costs of writing and designing the advertising material to be mailed; (d) costs and lead time required for printing the advertising material to be mailed; (e) costs of collating or assembling the elements of mailing and preparing the elements for delivery to the delivery service, such as the United States Postal Service; (f) postal regulations for acceptable sizes and weights of materials to be mailed; (g) postage costs for mailing and lead time necessary for expected delivery dates; and (h) costs of fulfilling requests for more information or product orders, or other information that may be solicited in the mailing.

For media such as newspaper, tv, radio, outdoor, the intelligent planning engine 26 applies the cost information against the weight level requirements as set down in the decision rules and outputs up to a maximum number of prototype plans 24 which are placed in a client “briefcase” 58. To remain manageable, the intelligent planning engine 26 defaults to five plans, although more or less plans may be created. The plans 24 differ in that each one places more emphasis on a different media type. For example, if a user has asked the engine 26 to use television, radio, newspaper and out-of-home media, the engine will return five plans 24. One plan will give greatest priority to television, one to radio, one to newspaper, one to outdoor and one will balance all four.

Alternative plans may also be provided within one selected media type. For example, where a set of alternative plans each relating to direct mailing is desired, the engine will produce a number of plans, with each plan having a different geographic region it covers and a different total mailing quantity. A second alternative plan includes only the geographic area that the user has indicated as the user's primary geographic target. A third alternative plan includes the geographic areas that have been designated by the user as of primary and second geographic area. A fourth alternative plan shows all geographic areas the user would like to consider. A fifth alternative plan shows the maximum geographic area the user can afford with their entered budget. Other alternative plans may be presented as well.

Each plan provides a description of the list to which the advertising pieces will be mailed. The description will include the geographic area to be covered, a description of the desired recipients such as demographic characteristics or product purchase behavior, a description of the type of printed piece to be mailed, the objective of the campaign, budget for the campaign and the projected return on investment for the campaign.

Each plan provides an easily read week-by-week allocation of media dollars and anticipated audience delivery to the various media types and classifications. Each plan includes an analysis of its audience delivery which is described in terms of “reach” which itself is defined as the percentage of target population exposed to the advertising at least once, “frequency” which is defined as the number of times the target audience who has been exposed to advertising will see the campaign, and “3+reach” which is defined as the percentage of the target audience that will see the campaign three or more times. To produce this report, the system 20 may import analyses from data services provided by outside vendors or retrieve analyses from the system host. These analyses are provided in real time by the system host or by one of its licensees. One example of a licensee capable of providing such analysis is Interactive Market Systems, Inc. Each plan also includes a narrative describing the rationale for the media and weight levels included.

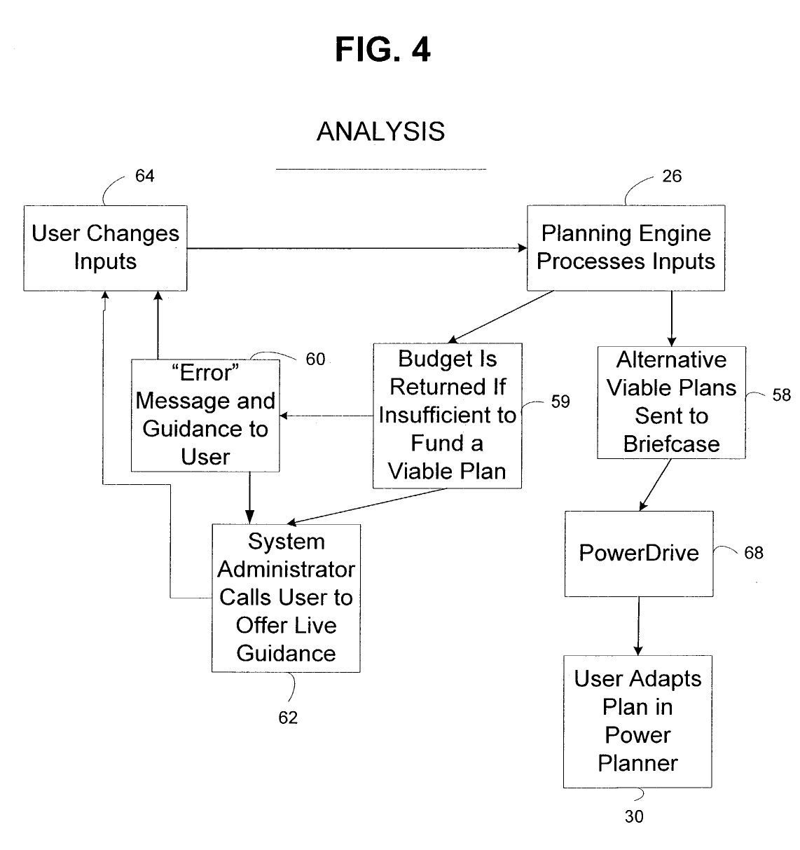

Referring now to FIG. 4, if the budget is not sufficient in light of the user's objectives and planning parameters to fund a viable plan as determined by the decision rules, a plan will not be returned 59. Instead, the user will receive messages 60 providing guidance or will receive live guidance 62 from a media expert assisting in the analysis. This guidance 60, 62 may include recommended changes to the parameters to use the budget more efficiently and effectively. If, after changes are input 64 and a second run of the intelligent planning engine is performed no plans are returned, the user may be referred to a live media expert for further assistance 62. Such guidance is available for all media types, including direct mailing.

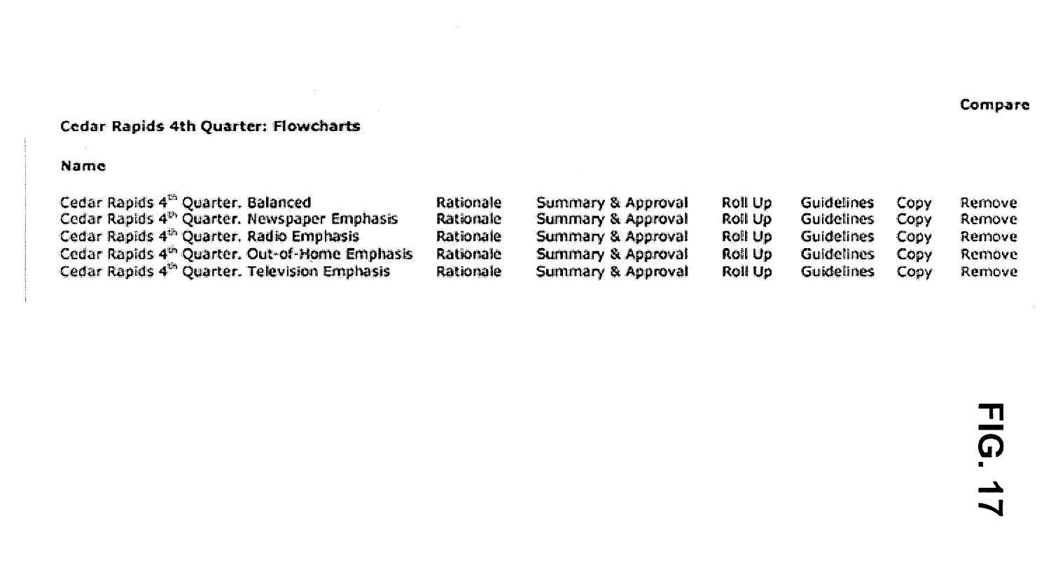

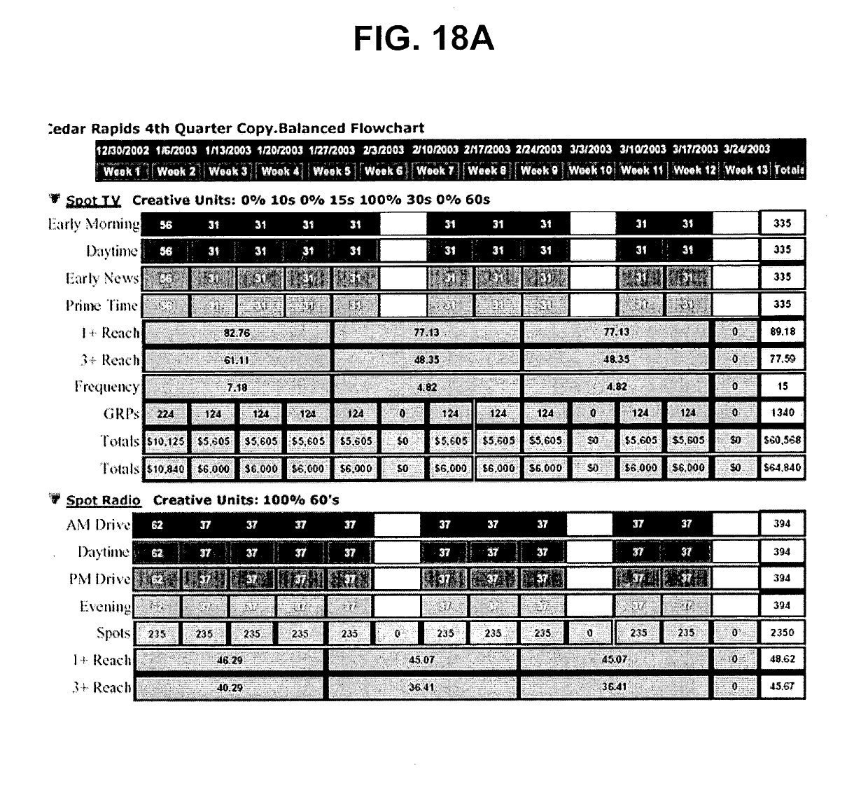

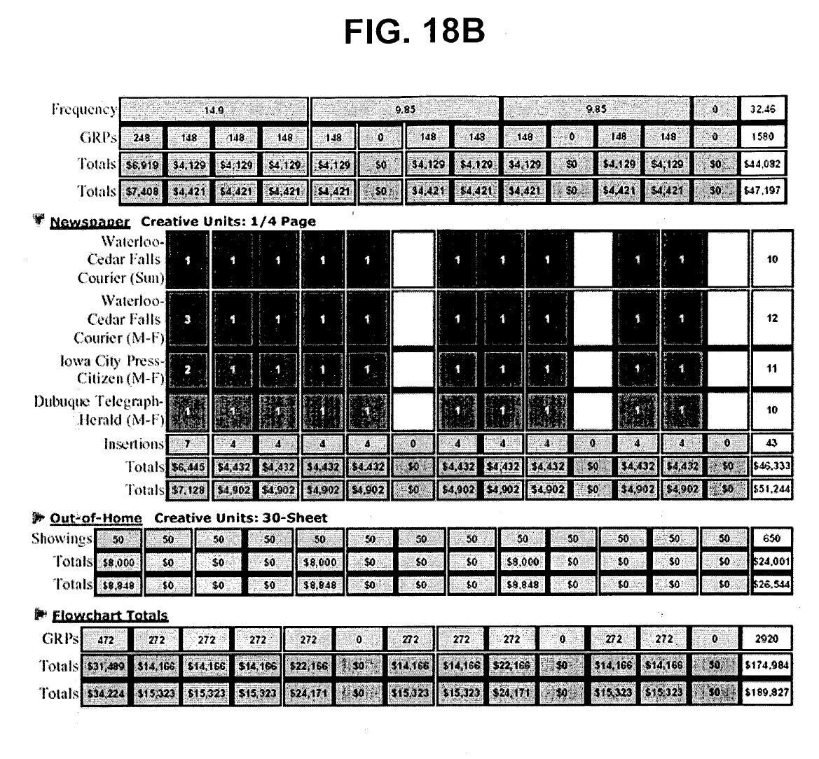

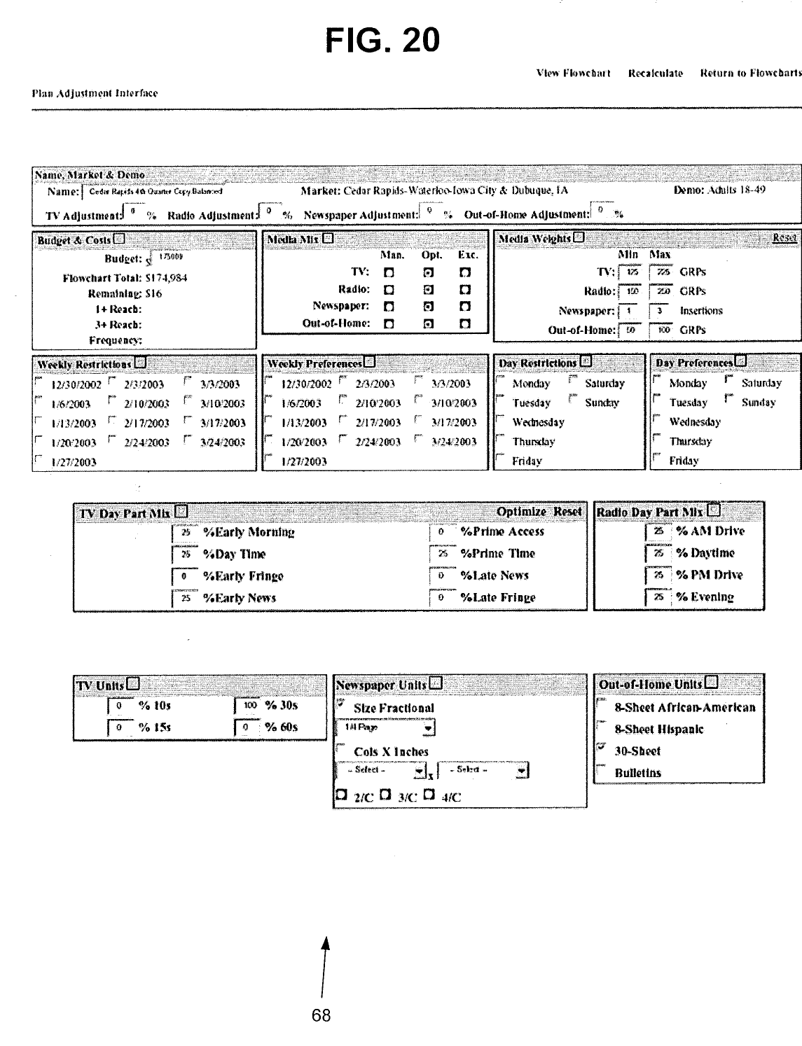

Plans generated by the engine 26 can be reviewed and adjusted by the user 64 with or without the help of a media professional, using a dashboard interface called the power drive 68. One embodiment of the power drive 68 is shown in FIG. 20. The user can test alternative scenarios to the plans generated by the computer by using the power drive 68 dashboard to change such variables as budget, weight levels, media mix, daypart mix, size or length or ad units and preferred or restricted timing variables. Where a direct mailing campaign is selected, the power drive may be used to vary the type of printed mailing pieces, timing, or postage classification of the mailings. The power drive then calls the intelligent planning engine 26 which subsequently recalculates and resaves that version of the media plan. Various finished plans are accessible through the plan flowchart list screen, as exemplified in FIG. 17. The briefcase also allows copying a plan or archiving a plan for later retrieval by clicking on a button or link. At the end of this stage, one plan is selected to be the approved plan 30.

This system 20 is advantageous over prior art planning tools in several respects. First, prior art systems failed to develop actual plan options based on user inputs of marketing criteria such as objectives, target audience, timing and budget. Prior art systems failed to provide and apply radio and TV planning costs defined as “costs-per-rating point” which are the accepted unit of cost measurement in the advertising industry. One prior art system is “Media Internet” which offers a database of broadcast stations and programs, but no cost data that can be practically used for media planning. In contrast, the data provided in the current system 20 maintains an updated cost database 56 from third party providers such as SQAD, Inc., which provides comprehensive local planning costs for TV and radio.

Advantageously, the system 20 may also utilize a proprietary database of comprehensive newspaper advertising rates. Unlike other commercially-available databases, such as Standard Rate and Data Service, which include only the highest rates offered by newspapers to national advertisers, the proprietary database contains many lower local rates available to local advertisers including contract rates that are most commonly earned and used by local advertisers.

Optionally, the system 20 also functions to identify media classifications such as newspapers or cable systems that can provide cost-efficient coverage of highly targeted geographic areas. As shown in FIG. 19, the user inputs the target geographic region 70. Although other criteria for selecting a region may be used, the criteria may include a list of zip codes, an area within a selected radius from a selected street location, or by selecting one or more counties.

The engine 26 then searches databases 56 to identify all newspapers or cable TV systems 72 with an audience in the selected geographic region 70. It next displays the available classifications 74 and also displays additional data on the classifications that is of interest to the user, including % target composition of each vehicle (% of that vehicle's total circulation or subscribers which is in the desired geography 70), % target coverage of each vehicle which is the % of households in desired zip code or counties that subscribe to the vehicle, and unit pricing for each vehicle. The user can select 76 any of these options for consideration in their plans.

The system 20 is configured to search additional alternatives 78, and calculates whether a broader geographic coverage might be more efficient than the highly targeted geographic options shown in the previous step. The user then confirms or changes the selection of media types such as newspapers or cable systems 80. The system 20 then develops alternative plans using the costs for any selected newspapers and cable systems 80, as well as costs for other media included in the proprietary database and used to develop plan 82.

Unlike prior art methods, the system 20 integrates the full range of functions required for media planning. The system 20 combines cost databases 56, generation of plans using pre-determined decision rules based on sound media planning principles, audience analysis (reach, frequency, 3+reach), and graphical flowcharting of plan options, all in one integrated system 20.

Stage 2 Media Negotiation and Buying

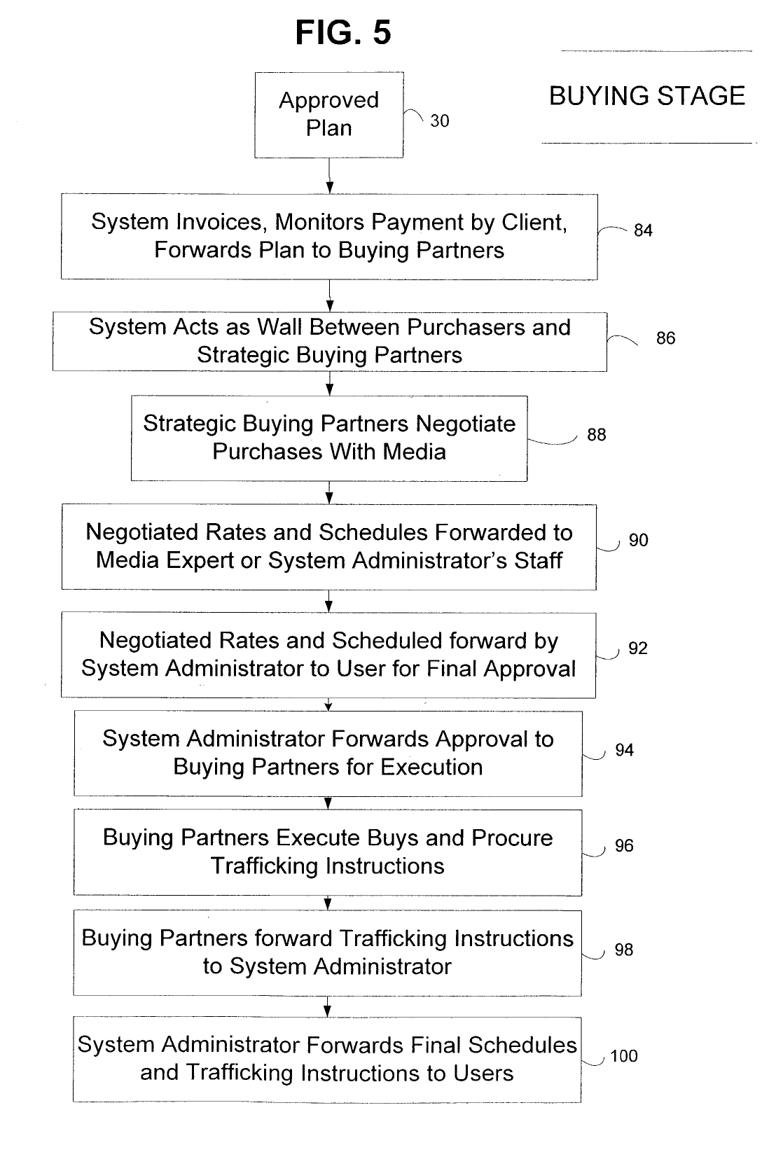

Referring now to FIG. 5, in a second stage, the system 20 facilitates purchase of services from media providers 88 in the user's selected local region. A host hosting the system may augment the value of such facilitation by partnering with a number of media buying firms that are each “best-of-class” in their respective advertising media. Such partners would have experience and influence in the media buying market that will allow the user to enjoy significant savings below the rates the user would receive without using the system. In the case of direct mailing, these partners would be leading direct mail advertising practitioners which may themselves be divided into different groups of specialties such as list rental, creative services, production and printing, collating and handling, preparation for and actual delivery to the US Postal Service, and offer fulfillment. These savings allow the problem of limited purchasing clout to be overcome. The system facilitates the negotiations and purchase of media prescribed in the approved plan from partnered vendors. Users that are normally not attractive to these vendors are able to receive their services using the system because the user is aggregated with other system users, reducing the overhead for vendors associated with handling an individual user.

User-approved plans 30 are forwarded to the buying partners who negotiate rates, recommend classifications (stations, programs, newspapers, out-of-home locations), and return recommended schedules to the system administrator all while the system administrator invoices and monitors 84 payments from the user. At this time, the system 20 acts as a wall 86 between the user and the strategic buying partner. The strategic buying partners also negotiate purchases 88 which are in turn forwarded back to the system administrator. The system administrator then forwards these recommended schedules 90 to the user who reviews the plan for final approval 92. Tutorials are also offered at this point to help users evaluate the buys that have been submitted for their approval. When final approval is provided, the system forwards this approval to the buying partners 94. The buying partners next execute the media buy 96 and provide key buy information back to the system 20 including but not limited to trafficking instructions and schedules. This information is forwarded 98 to the system administrator, who in turn forwards the final schedules and trafficking instructions to the user 100. Communication between the parties is automated and electronic for time and cost savings.

Stage 3. Monitoring, Maintenance, and Post-Analysis

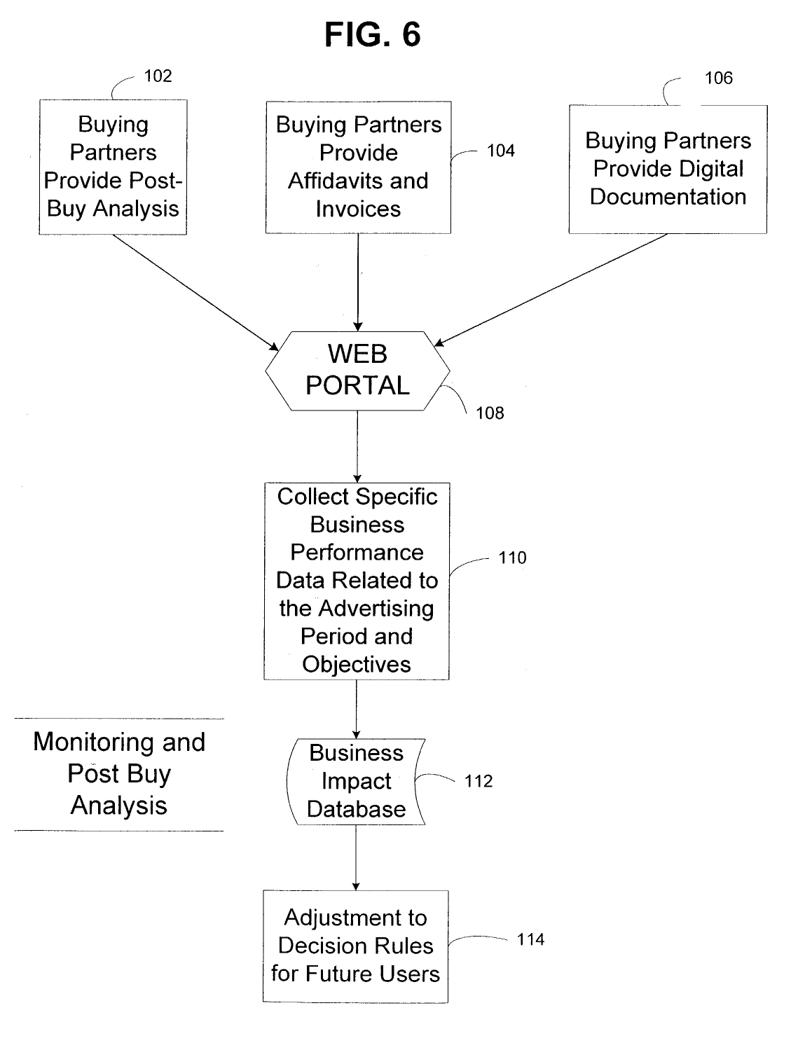

Referring now to FIG. 6, in the third stage, the user is provided with post-buy analysis 102, affidavits and invoices for media buys 104, and digital documentation 106 when available. This information may be stored in an on-line database accessible using the system through a common web portal 108.

As the number of users of the system 20 achieves a critical mass, the system 20 will provide a proprietary results accountability measurement tool. This tool will be used to collect specific business performance data from users related to the advertising period and objectives 110. This data will be mapped against the amount spent to demonstrate the actual impact of the spending on the user's business performance and stored in a business impact database 112. As this database grows, the information contained therein may be used to adjust the decision rules to provide further efficiencies to later plans and purchases 114.

Decision Rules

A set of media buying decision rules are used by the system 20 to determine media buying allocations. These allocations are dependent on the type of media to be purchased, the flighting pattern to be employed, (a flighting pattern determines the number and the dates of the weeks in which advertising will be scheduled) and the amount of media weight, such as advertising messages delivered to a target audience, to be scheduled in each medium utilized, in each of those weeks.

The first component of the decision rules relates to priorities for the type of media to be purchased. The decision rules employ a set of priorities for each of the media types available on the system. As a default, the priority is set in rank order from highest priority to lowest priority for four media types: TV, Radio, Newspaper, Outdoor. These priorities can be adjusted by the user in the interactive worksheets. The user may choose to exclude any of the media types, or raise their priority by indicating that the medium is “mandatory.” These four particular media types are shown for illustrative purposes only. Other combinations or media types may be used depending on the user's needs and preferences.

A second component of the decision rules is the flighting patterns. A standard campaign is 13 weeks long although other durations may be selected. As an example, in the default 13-week campaign period, the standard flighting pattern will call for advertising to be scheduled during the first five weeks of the campaign, followed by a one-week hiatus, followed by a two week period of advertising, then another one-week hiatus, followed by another two-week period of advertising, one more one-week hiatus and then a final week of advertising.

The third component of the decision rules is the series of minimum and maximum weekly weight levels that are recommended for each medium and objective. The minimum/maximum weight levels included in the system are shown in Table I.

TABLE I

| | Motivate Immediate Action | | | |
|---|---|---|---|---|
| | Objective | | Enhance Image Objective | |
| Medium | Minimum | Maximum | Minimum | Maximum |
| TV | 125 GRPs/wk. | 225 GRPs/wk. | 75 GRPs/wk. | 125 GRPs/wk. |
| Radio | 150 GRPs/wk | 250 GRPs/wk. | 110 GRPs/wk. | 175 GRPs/wk. |
| Newspaper | 1 insertion/wk. | 3 insertions/wk | 1 insertion/wk. | 2 insertions/wk |
| Outdoor | #50 show./mo | #100 | #50 show./mo | #75 show./mo. |
| | | show./mo. | | |

The decision rules are driven by the user's data input from the interactive worksheets 36. There the user decides what the goal of the campaign will be. For example, the goal may be to motivate consumers to purchase a certain product. Another example might be to enhance the image of the user without actually advertising to sell a particular product. Depending on the goal, the decision rules will allocate a certain minimum and maximum number of weighted purchasing points, commonly referred to as gross rating points or “GRPs,” to a certain media vehicle over a certain number of weeks.

There are at least two variations for flighting patterns produced by the system 20. In one flighting pattern embodiment, the system 20 creates a media plan that employs and gives equal emphasis to all the media included for consideration, referred to as “balanced” plans. When calculating “balanced” plans, the system 20 first allocates a budget amount sufficient to fund one week of support in the first priority medium (e.g. TV), at the minimum recommended weight levels appropriate to the user's stated objective. The system 20 next adds one week of support at the minimum recommended weight level for the second priority medium (e.g. radio), followed by the third, fourth, and so forth until all selected media types have been allocated minimum recommended weight levels. The system 20 is also programmed to address certain media-specific characteristics, such as when Outdoor is the medium to be addressed, one month is budgeted rather than one week, because one month is commonly the minimum length of time for which outdoor advertising space can be purchased.

After each selected medium is budgeted a minimum recommended weight level, if there is available budget remaining, the system will continue by allocating budget to fund a second week in each medium in the same priority order. It will continue by adding weeks in all media until minimum levels of support are scheduled in all the weeks in which advertising is desired. After advertising has been scheduled in all media under consideration for all weeks desired, the system 20 will return to the first week of the schedule and add weight in increments of a selected number of GRPs for each of the remaining media. Certain distributions have been found to be advantageous at this point in the allocation process, such as, for example, allocating 10 GRPs per week for TV and radio, one newspaper insert per paper per week, and an additional #25 showings per month in outdoor advertising.

The system 20 will continue with this iteration throughout all weeks of the campaign in which advertising is desired. If at the end of this second allocation of budget there is budget remaining, the system will continue to add weight in the same increments across each week in which advertising is desired. This iteration will continue until either the budget has been exhausted or until maximum weight levels recommended by the system have been achieved.

In a second decision rule embodiment, the system 20 creates a plan giving greatest priority first to a single medium. In this process, which creates an “emphasis” plan, the system first allocates budget sufficient to buy the minimum recommended amount of media weight in the first priority medium for all the desired weeks of the campaign. If there is budget remaining, the system 20 will next allocate budget sufficient to buy the minimum recommended amount of media weight in the second priority medium for all the desired weeks of the campaign. If there is budget remaining, the system 20 will next allocate budget sufficient to buy the minimum recommended amount of media weight in the third priority medium (e.g. newspaper) for all the desired weeks of the campaign. And if there is budget remaining, the system will allocate budget sufficient to buy the fourth priority medium (e.g. outdoor) for all the desired weeks of the campaign. If there is budget remaining, the system 20 will then return to the first priority medium and allocate budget sufficient to buy additional weight (in increments of 10 GRPs (TV/Radio), 1 insertion/week), or #25 showings (outdoor) until maximum recommended weight levels have been achieved.

After maximum weight levels have been achieved in the first priority medium, if there is still budget remaining, the system will allocate budget to the second priority medium, the third, the fourth, and so forth until maximum weight levels in each medium will have been achieved or until the budget has been exhausted.

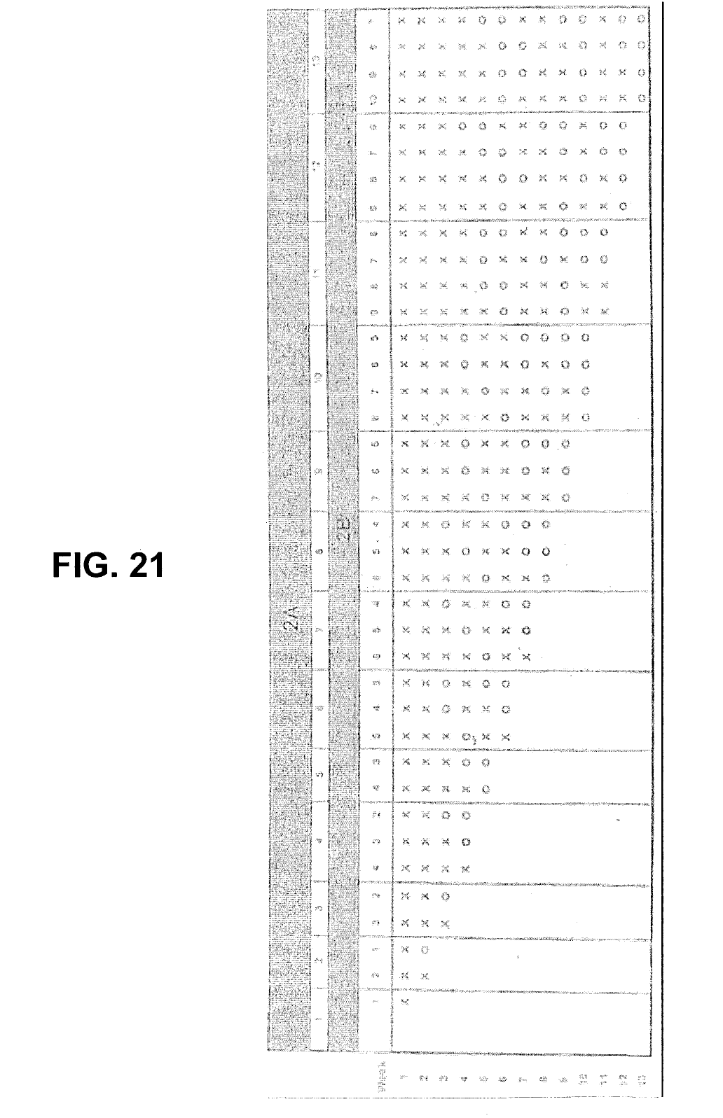

As another illustration, in FIG. 21, the user has already expressed various preferences using the interactive work sheets 36. The preference that would call this decision rule table would be to “Motivate Immediate Action.” Examples of a “Motivate Immediate Action” type goal include persuading a consumer to buy a product, vote in an election, or attend an event within a specified time frame. In this illustration, the user has expressed a preference for including television in the media mix. FIG. 21 is an example of the decision rules that would be called to calculate the plan alternative that would provide a television emphasis. Because it is advantageous to advertise in shorter flights (periods) with heavier weights the decision rules provide flighting patterns that indicate total number of weeks they will actually be running television advertising. Row 2A lists all the possible numbers of weeks that might be included in the campaign, as specified by the user. Once the total number of weeks to run the T.V. ad has been selected, the computer program reads down the column to see in which actual weeks the advertisement should be run. For example, if the budget allows for 9 weeks of total television advertising, the computer program goes to ROW 2A, and looks at the 9 week column. Then the decision rule considers other inputted preferences to determine whether to run the ad for 7 weeks, 6 weeks, or 5 weeks in total. Assuming the result is to actually run the television ad for 5 weeks, reading down the column, the decision rule would dictate that within a 13 week campaign, the advertisement should be run in the 1^{st}, 2^{nd}, 3^{rd}, 5^{th} and 6^{th} weeks. Selection of the most effective weeks to advertise based on expertise in media purchasing and more specifically, recognizing that certain strategies, such as advertising more frequently at the beginning of the campaign, is advantageous. Decision rules such as in FIG. 21 function together to provide a week-by-week media plan for the multitude of possible combinations that can be created by the user's budget and media preferences.

Decision rules are applied by the system 20 to generate recommendations when the selected medium is Direct Mail. Based on the user's inputs regarding marketing objectives, desired geography to be covered; industry, product or service category; budget, and desired return on investment (ROI); the system will call upon decision rules to recommend a type of mailing list (such as a “responder” list, which consists of names and addresses of individuals who have responded to similar offers in the past; or a “compiled” list of names and addresses of individuals with characteristics that make them similar to persons who have responded to similar offers in the past. As another example of the decision rules called when the medium selected is Direct Mail, the system will recommend a type of printed piece (page size, paper weight, number of pages in piece, envelope vs. self-mailer) based on the user's inputs. The system 20 also recommends a mailing quantity based on the user's inputs.

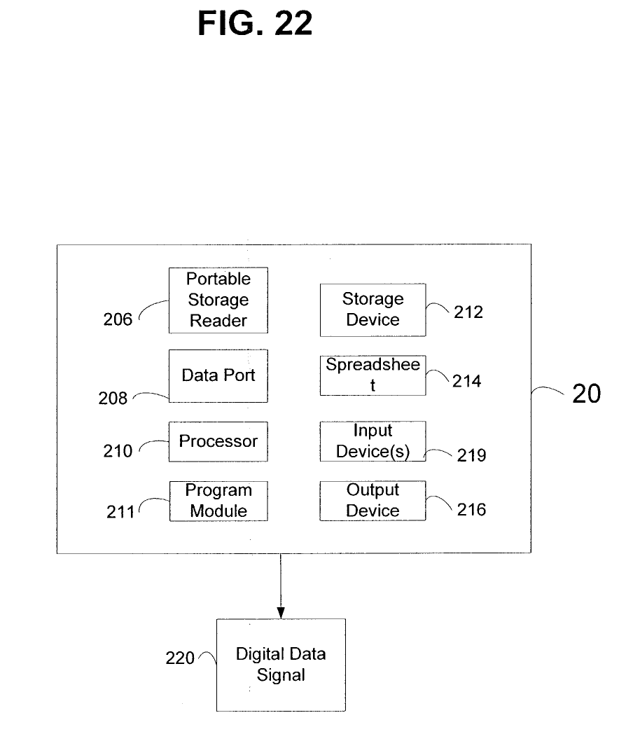

Referring now to FIG. 22, a system 20 for implementing the above method includes a portable storage reader 206 such as, for example, a floppy disk, CD-ROM, CDR, DVD, DVDr, DVD+RW, tape, memory stick, or removable hard drive containing historical tick data. This portable storage reader 206 communicates with a processor 210 to perform the functions described above. The system 20 may also include a spreadsheet program 214 or program module 211. The term “module” referenced in this disclosure is meant to broadly cover various types of software code including but not limited to routines, functions, objects, libraries, classes, members, packages, procedures, or lines of code together performing similar functionality to these types of coding. A storage device 212, such as, for example, a floppy drive, hard drive, tape drive, a CDR, or a CDRW, is also included for storing and retrieving software code, data, both used to run the software and inputted by the user, and other purposes to retrieve and calculate needed information. Other data used by the system 20, such as media pricing, may be retrieved over a communications network such as the Internet by a data port 208, such as, for example, a network card, a serial port, parallel port, firewire port, or network card configured to communicate with a network wirelessly. Also, data may be stored remotely, such as on a data server, and may likewise be accessed using the data port 208.

The system 20 also includes an output device 216, such as, for example, a monitor or printer, or network interface to prompt the user for selections or data described above and to show results and reports. The system 20 also includes one or more input devices 219, such as, for example, a keyboard and mouse, to allow a user to communicate with the system 20.

The system 20 may also include a translating device, such as for example, a compression chip on a network card, for translating data inputted and produced by the system into a digital data signal 220. The data signal 220 may be transmitted via a carrier wave to a remote computer. The data signal 220 may be configured to operate over commonly used network or communications protocols, such as TCP/IP or IPX. With such protocols, the system 20 processes the data signal 220 into a compressed signal of various length codewords, encrypts the compressed signal, and transmits compressed and encrypted signal to the remote computer. The remote computer is programmed to decompress and decrypt the data signal 220 so that the data found therein may be accessed.

The system 20 may also be configured such that a user logs onto the system 20 remotely. Any client/server protocol may be used with this configuration. For example, a user may use a commonly available web browser such as Internet Explorer to log onto a secure web site on a system configured to act a server. The various interfaces, functions, routines, calculations and so forth may programmed using a variety of software products or languages, but have advantageously been written in a combination of the C# programming language in combination with Visual Studio .NET from Microsoft Corporation. To allow the system 20 to function over the Internet, the software may also be written using XML, HTML, and Microsoft SQL Stored Procedures.

While a preferred embodiment of the disclosure is shown and described, it is envisioned that those skilled in the art may devise various modifications and equivalents without departing from the spirit and scope of the systems and method of this disclosure.

1. A method for planning and executing a marketing communication using a computer-implemented system, the method comprising the steps of:
providing a user with interactive guided worksheets for inputting a plurality of campaign criteria data;
providing an intelligent planning engine for generating a plurality of alternative media plans based on the plurality of campaign criteria data and on a plurality of pricing information retrievable from a cost database;
allowing the user to manipulate the alternative plans until the user is satisfied and selects a user-approved plan; and
automating an approval for a purchase of a plurality of media classifications that are described in the user-approved plan.

2. The method of claim 1, wherein the cost database contains pricing information related to media in a selected local geographic region.

3. The method of claim 2, wherein the proprietary pricing information relates to discounted marketing pricing usually made available only to large purchasers.

4. The method of claim 1, wherein allowing the user to manipulate the alternative plans is facilitated by a dashboard interface.

5. The method of claim 1, wherein the plurality of alternative media plans includes different plans, each different plan placing emphasis on a different media type, wherein the media type is selected from a group including: radio, television, Internet advertising, direct mailing, outdoor advertising, sponsorship of promotional events, product sampling, and stadium signs.

6. The method of claim 1, wherein the plurality of alternative media plans includes a balanced plan.

7. The method of claim 1, wherein the plurality of alternative media plans includes different plans each related to a selected media type, each different plan based on a different geographic region type.

8. The method of claim 7, wherein the selected media type is direct mailing.

9. The method of claim 1, wherein the intelligent planning engine is driven by a set of decision rules.

10. The method of claim 1, further comprising providing a tool for collecting performance data from the media campaign accessible by the user.

11. A system for planning and executing a media campaign comprising: a storage device, a means for receiving data; memory; a program module; an output device; a cost database, and a processor responsive to a plurality of instructions from the program module, being operative to:
provide a user with interactive guided worksheets viewable on an output device and allowing the user to enters campaign criteria data into the interactive guided worksheets using the input device;
communicate with an intelligent planning engine to generate a plurality of alternative media plans to be displayed on the output device, the alternative media plans being based on the plurality of campaign criteria data and on a plurality of pricing information retrievable from the cost database;
allow the user to manipulate the alternative plans until the user is satisfied and selects a user-approved plan; and
automate an approval of a purchase of a plurality of media classifications that are described in the user-approved plan.

12. The system of claim 11, wherein the cost database contains pricing information related to media in a selected local geographic region.

13. The system of claim 12, wherein the pricing information relates to discounted marketing pricing usually made available only to large purchasers.

14. The system of claim 11, wherein the cost database is updated by importing from an external database of one or more vendors.

15. The system of claim 11, wherein to allow the user to manipulate the alternative plans is facilitated by a dashboard interface.

16. The system of claim 11, wherein the plurality of alternative media plans includes different plans, each different plan placing emphasis on a different media type, wherein the media type is selected from a group including: radio, television, Internet advertising, direct mailing, outdoor advertising, sponsorship of promotional events, product sampling, and stadium signs.

17. The system of claim 16, wherein the plurality of alternative media plans includes a balanced plan.

18. The system of claim 11, wherein the plurality of alternative media plans includes different plans each related a selected media type, each different plan based on a different geographic region type.

19. The system of claim 18, wherein the selected media type is direct mailing.

20. The system of claim 11, wherein the intelligent planning engine is driven by a set of decision rules.

21. The system of claim 11, further comprising providing a tool for collecting performance data from the media campaign accessible by the user.

22. A computer program product for use with a computer, said computer program product comprising:
a module for providing a user with interactive guided worksheets for inputting a plurality of campaign criteria data;
a module for providing an intelligent planning engine for generating a plurality of alternative media plans based on the plurality of campaign criteria data and on a plurality of pricing information retrievable from a cost database;
a module allowing the user to manipulate the alternative plans until the user is satisfied and selects a user-approved plan; and
a module for automating an approval of a purchase of a plurality of media classifications that are described in the user-approved.

23. The computer program product of claim 22, wherein the cost database contains pricing information related to media in a selected local geographic region.

24. The computer program product of claim 23, wherein the pricing information relates to discounted marketing pricing usually made available only to large purchasers.

25. The computer program product of claim 22, wherein the cost database is updated by importing from an external database of one or more vendors.

26. The computer program product of claim 22, wherein to allow the user to manipulate the alternative plans is facilitated by a dashboard interface.

27. The computer program product of claim 22, wherein the plurality of alternative media plans includes different plans, each different plan placing emphasis on a different media type, wherein the media type is selected from a group including: radio, television, Internet advertising, direct mailing, outdoor advertising, sponsorship of promotional events, product sampling, and stadium signs.

28. The computer program product of claim 27 wherein the plurality of alternative media plans includes a balanced plan.

29. The computer program product of claim 22, wherein the plurality of alternative media plans includes different plans each related to a selected media type, each different plan based on a different geographic region type.

30. The computer program product of claim 29, wherein the selected media type is direct mailing.

31. The computer program product of claim 22, wherein the intelligent planning engine is driven by a set of decision rules.

32. The computer program product of claim 22, further comprising providing a tool for collecting performance data from the media campaign accessible by the user.

33. A data signal embodied in a carrier wave comprising: instructions for receiving the objects transmitted by carrier wave and media planning data including:
compilable data that allows a user's terminal to display an interactive guided worksheets and inputting a plurality of campaign criteria data in the interactive guided worksheets;
compilable data representing a plurality of alternative media plans based on the plurality of campaign criteria data and on a plurality of pricing information retrievable from a cost database;
compilable data that allows the user to manipulate the alternative plans until the user is satisfied and select a user-approved plan; and
compilable data for automating an approval of a purchase of a plurality of media classifications that are described in the user approved plan.

34. The data signal of claim 33, wherein the cost database contains pricing information related to media in a selected local geographic region.

35. The data signal of claim 34, wherein the pricing information relates to discounted marketing pricing usually made available only to large purchasers.

36. The data signal of claim 33, wherein the cost database is updated by importing from an external database of one or more vendors.

37. The data signal of claim 33, wherein to allow the user to manipulate the alternative plans is facilitated by a dashboard interface.

38. The data signal of claim 33, wherein the plurality of alternative media plans includes different plans, each different plan placing emphasis on a different media type, wherein the media type is selected from a group including: radio, television, Internet advertising, direct mailing, outdoor advertising, sponsorship of promotional events, product sampling, and stadium signs.

39. The data signal of claim 38 wherein the plurality of alternative media plans includes a balanced plan.

40. The data signal of claim 33, wherein the plurality of alternative media plans includes different plans each related to a selected media type, each different plan based on a different geographic region type.

41. The data signal of claim 40, wherein the selected media type is direct mailing.

42. The data signal of claim 33, wherein the intelligent planning engine is driven by a set of decision rules.

43. The data signal of claim 33, further comprising providing a tool for collecting performance data from the media campaign accessible by the user.

44. A method of populating a media campaign, the method comprising the following steps:
selecting a set of media types;
selecting a duration for the media campaign;
designating certain weeks in the media plan as hiatus weeks and certain weeks as active weeks;
setting a minimum and maximum weekly weight level of purchasing points for each active week; and
allocating purchasing points to each active week according to a selected order of priority.

45. The method of claim 44, wherein setting a minimum and maximum weekly weight level is based on a motivate action objective.

46. The method of claim 44 wherein setting a minimum and maximum weekly weight level is based on an enhance image objective.

47. The method of claim 44, wherein the order of priority is media-emphasis.

48. The method of claim 44, wherein the order of priority is balanced.
